(19) United States
(12) Patent Application Publication
(10) Pub. No.: US 2022/0191256 A1
(43) Pub. Date: Jun. 16, 2022

(54) AGNOSTIC DATA COLLECTION PLATFORM

(71) Applicant: NCR Corporation, Atlanta, GA (US)

(72) Inventors: Aistis Taraskevicius, Dundee (GB); Ian Alexander Cathro, Dundee (GB); Gordon David Chisholm, Perth (GB)

(21) Appl. No.: 17/123,341

(22) Filed: Dec. 16, 2020

(51) Int. Cl. H04L 29/06; H04L 12/24

(52) U.S. Cl. CPC H04L 65/1073; H04L 65/1006; H04L 41/046; H04L 41/0213; H04L 65/1046

(57) ABSTRACT

A collector is configured to obtain management data associated with a managed device. The collector formats the management data in a platform independent message and sends to a hardware/Operating System (OS) broker. The broker forwards the message to a hardware/OS agnostic agent, who is subscribed to receive the management data. The agent adds identifying information associated with the managed device to the management data of the message, packages the management data, and forwards the management data to a data collection server or an endpoint device where the management data with the identifying information may be processed by a remote management workflow for managing the managed device.

### BACKGROUND

Typically, endpoint device management is specific to the hardware types of the managed endpoint devices, the Operating System (OS) platforms of the endpoint devices, and the management data produced by the applications (software) on the endpoint devices. A single enterprise may attempt to manage many different types of devices simultaneously via a complex remote management system. This usually requires customized management applications on each device to remotely report out events and other information logged by the device's applications. The management applications must also gather endpoint device identifying information so that the remote management system can uniquely associate the reported events and information with the appropriate endpoint devices.

Still further some management applications may report event information through real-time messages to remote server management services; this may require that the remote server management services be on a same OS platform as that which is associated with the reporting management applications. This can mean that an enterprise must deploy multiple different remote servers as part of its remote management system.

In fact, the manner in which events and information are collected and reported out to remote server management services can vary significantly. Some management applications may store information in a designated remote server location, others may send real-time messages to the remote server management services, some may store information within a log on the corresponding endpoint device for remote collection by a remote server management service, while still others may update the information to a remote database.

All these factors and others makes it a significant challenge for an enterprise to assemble and manage its diverse set of endpoint devices via a customized remote management system. Any upgrade, patch, and/or newly installed resource, which is associated the endpoint devices' applications, the management applications, the endpoint devices' OS's, the remote servers' OS's, and/or the remote management services can create a significant amount of software engineering resources to ensure that an enterprise's management system continues to interoperate with its endpoint devices as expected.

That is, existing remote management systems are tightly coupled to the hardware, software, and OS platforms of their managed endpoint devices. As a result, it is costly for enterprises to maintain their remote management systems regardless as to whether the enterprise outsources management to a third party or self-manages inhouse.

### SUMMARY

In various embodiments, methods and a system for operating an agnostic data collection platform are provided.

According to an aspect, a method for operating an agnostic data collection platform is presented. A registration message posted by a data collector with a broker is received. Identifying information for a managed device that associated with the data collector is obtained from the registration message. The data collector is associated with the identifying information. A data message posted by the data collector with the broker is acquired and managed data is separated from the data message. The managed data with the identifying information is sent to an endpoint device.

### BRIEF DESCRIPTION OF THE DRAWINGS

FIG. 1A is a diagram of a system for operating an agnostic data collection platform, according to an example embodiment.

FIG. 1B is a diagram illustrating an architectural process flow of the system from FIG. 1A, according to an example embodiment.

FIG. 1C is a diagram illustrating state process flows of the system from FIG. 1A, according to an example embodiment.

FIG. 1D is a diagram illustrating process flows 100D associated with collecting management data from a managed device associated with the system of FIG. 1A, according to an example embodiment.

FIG. 2 is a diagram of a method for operating an agnostic data collection platform, according to an example embodiment.

FIG. 3 is a diagram of another method for operating an agnostic data collection platform, according to an example embodiment.

### DETAILED DESCRIPTION

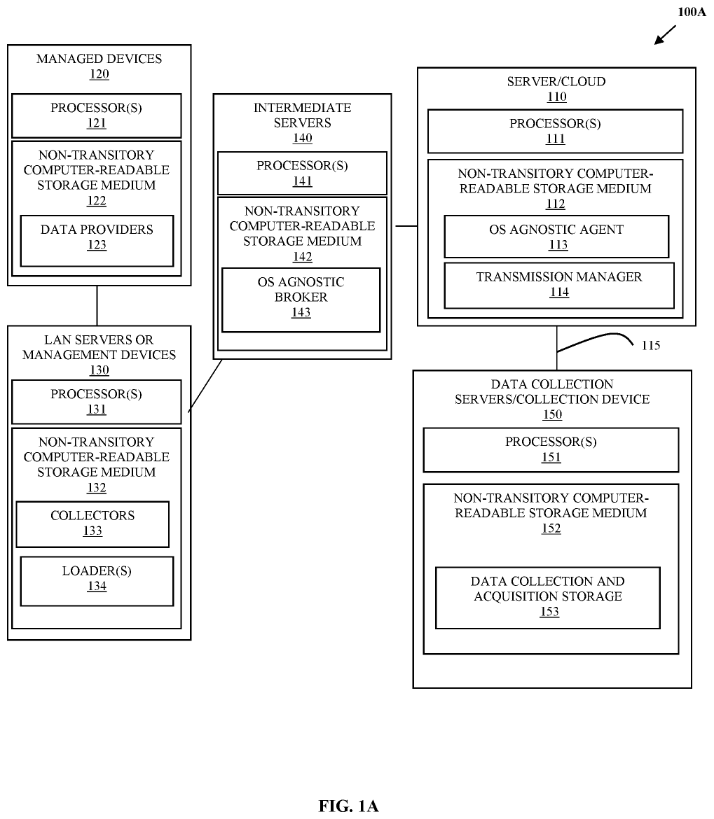

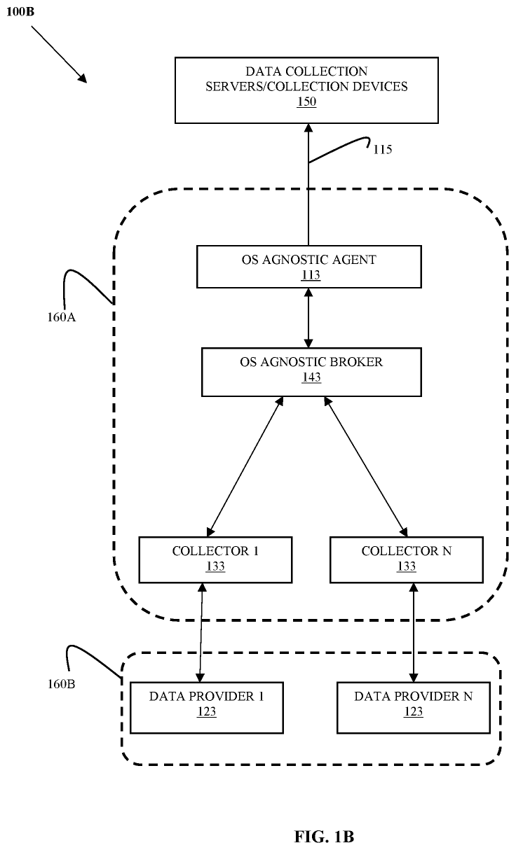

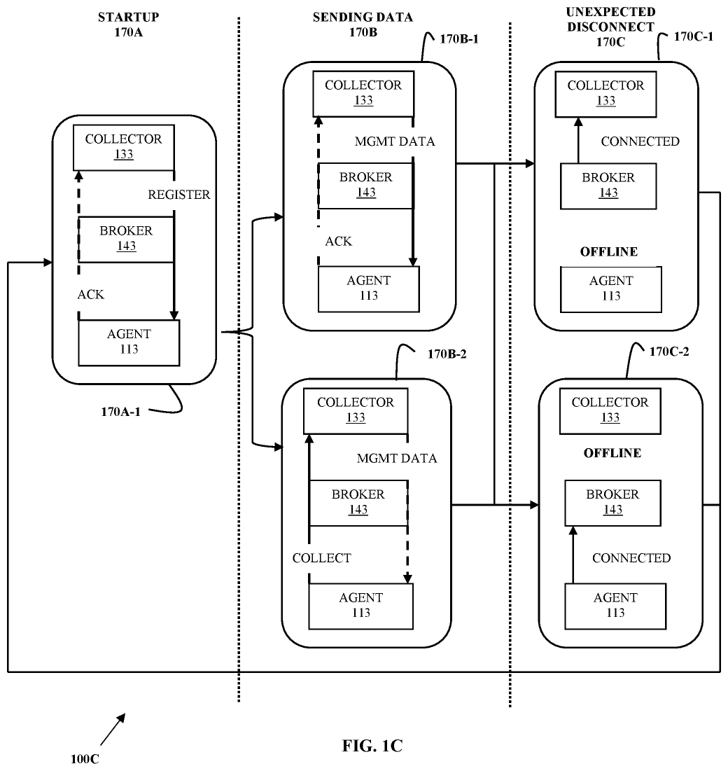

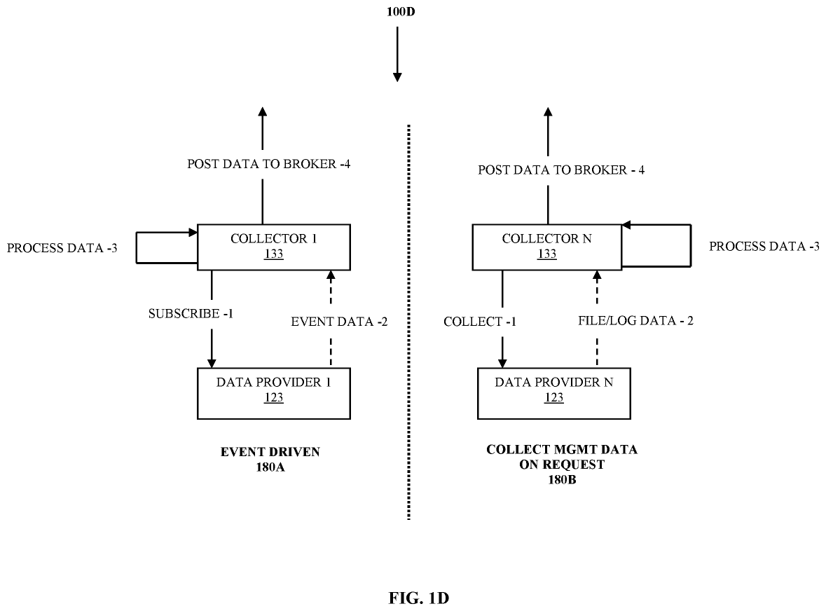

FIG. 1A is a diagram of a system 100A for operating an agnostic data collection platform, according to an example embodiment. It is to be noted that the components are shown schematically in greatly simplified form, with only those components relevant to understanding of the embodiments being illustrated.

Furthermore, the various components (that are identified in the FIG. 1A) are illustrated and the arrangement of the components is presented for purposes of illustration only. It is to be noted that other arrangements with more or with less components are possible without departing from the teachings of operating an agnostic data collection platform, presented herein and below.

As will be demonstrated more completely herein, system 100A provides a cross-industry, cross-programming language, and OS agnostic data collection platform. A three-layered architecture for the platform is presented. A first layer comprises an agent implemented in an OS agnostic programming language. The agent manages a plurality of collectors (third layer) through a broker (second layer) and the agent sends received management data for a managed device to a data collection server/data collection device where the management data may be obtained and subsequently processed by a remote management workflow associated with a remote management system in manners that are specific to an enterprise associated with the remote management system. The broker (second layer) enables communication between the agent (first layer) and the collectors (third layer) using an OS agnostic and Open Source publish-subscribe protocol. The collectors collect management data from managed devices, format the management data in the publish-subscribe protocol, and publish the management data with the broker. The broker identifies the agent as a subscriber to the published management data and forwards to the agent. System 100A is easy to integrate and decouples management data collection from the specific environments and platforms permitting more efficient remote management.

“Managed data” and “management data” may be used interchangeably and synonymously herein and below. This is event, message, and/or log data produced by or captured by data providers for a managed device. A software resource may produce the managed data, which is then captured by a data provider or the data provider may produce the managed data based on monitoring both hardware and software resources on the managed device.

System 100A comprises a server/cloud 110, managed devices 120, Local Area Network (LAN) servers/management devices 130 (optional), one or more intermediate servers 140, and one or more data collection servers/collection devices 150.

Server/cloud 110 comprises one or more processors 111 and a non-transitory computer-readable storage medium 112. Medium 112 comprises executable instructions for an OS agnostic agent 113 and a transmission manager 114. When executable instructions are provided from medium 113 to processor 111, this causes processor 111 to perform operations discussed herein and below with respect to OS agnostic agent 113 and transmission manager 114.

Each managed device 120 comprises a processor 121 and a non-transitory computer-readable storage medium 122. Medium 122 comprises executable instructions for data providers 123. When executable instructions are provided from medium 122 to processor 121, this causes processor 121 to perform operations discussed herein and below with respect to data providers 123.

Each optional LAN server/management device 130 comprises a processor 131 and a non-transitory computer-readable storage medium 132. Medium 132 comprises executable instructions for collectors 133 and loaders 133. When executable instructions are provided from medium 132 to processor 131, this causes processor 131 to perform operations discussed herein and below with respect to collectors 133 and loaders 134.

Each intermediate server 140 comprises one or more processors 141 and a non-transitory computer-readable storage medium 142. Medium 142 comprises executable instructions for an OS agnostic broker 143. When executable instructions are provided from medium 142 to processor 141, this causes processor 141 to perform operations discussed herein and below with respect to OS agnostic 143.

It is to be noted, that collectors 133 and loaders 134 are part of system 100A, such that when system 100A does not comprise the optional LAN servers/management devices 130, the collectors 133 and loaders 134 reside on the managed devices 120 and are processed by processor 121. Thus, for purposes of the discussion that follows collectors 133 and loaders 134 may be executed on optional LAN servers/management devices 130 or managed devices 120.

In an embodiment, system 100A also comprises a one-way secure connection 115 to data collection servers/collection devices 150. That is, server/cloud 110 cannot interact or pull managed data from data collection servers/collection devices 150 once the managed data is sent over a one-way secure connection 115 to data collection servers/collection devices 150. Transmission manager 114 simply transmits the managed data over a wired or wireless connection to data collection servers/collection devices 150. Furthermore, server/cloud 110 does not retain copies of any processed managed data. This ensures that an enterprise's managed data can only be accessed and obtained from data collection servers/collection devices 150, which provides security with respect to a given enterprise's managed data. Transmission manager 114 may send the managed data over 115 along with a put/write command to store or stream managed data in data collection and acquisition storage 153.

In an embodiment, system 100 comprises a two-way secure connection 115 to data collection servers/collection devices 150.

In an embodiment, system 100A comprises a standalone device or portable memory storage device that is written to by transmission manager 114, such that in this embodiment there is no data collection server 150; rather, the managed data is stored on a collection device 150 that is not connected to any network or is a portable memory storage device (such as a Universal Serial Bus (USB) memory stick). Also, in this embodiment connection 115 may be a wired USB connection.

The interaction between the components of system 100A are now discussed with reference to FIGS. 1A-1D.

FIG. 1B illustrates an architectural process flow 100B for system 100A. The dotted grouping 160A represent the logically formed agnostic data collection platform comprising OS agnostic agent 113, OS agnostic broker 143, and collectors 133 (1 through N). The dotted grouping 160B represents the managed device-specific environments of the managed devices 120 along with its data providers 123 (1 through N). Data providers 123 are management applications or other workflow applications that execute on the managed devices 120 and produce managed data, such as events, messages, and/or logs.

Each collector 133 is responsible for obtaining/collecting managed data when produced by a specific data provider 123 or a specific set of data providers 133 for a given managed device 120. That is, a single collector 133 is configured to listen for, detect, and obtain managed data generated by a specific data provider 123 or set of data providers 123 for a specific managed device 120.

The collector 133 itself may be implemented as a generic application capable of being configured via one or more configuration files to listen for or detect specific managed data produced by a specific data provider 123 or a set of data providers 123.

Loader 134 permits instances of the generic collector 133 (instances 1 and N in FIG. 1B) to be loaded and initiated for execution on LAN servers/management devices 130 and/or the specific managed devices 120 within specific OS's associated with the corresponding managed devices 120. Each specific running instance of collector 133 may further utilizes the configuration files assigned to it by the corresponding loader 134 when it is first initialized to listen for or detected specific managed data from a specific data provider 123 (1 or N in FIG. 1B) or a specific set of data providers 123 (FIG. 1B does not illustrate a single collector 133 collecting managed data from multiple data providers 123; but as discussed above this can occur in some embodiments via the configuration files).

In an embodiment, multiple loaders 134 are processed to load multiple instances of collectors 133 when generic collectors 133 are written in different programming source codes. Here, a single loader 134 is used for each different source code.

In an embodiment, one or more of collectors 123 self-load and initiate without a need for loader 134.

In an embodiment, the configuration files identify a channel, file location, and/or file name by which the collector instance 123 can monitor for a presence of managed data produced by its data provider 123 or set of data providers 123.

In an embodiment, the configuration files identify any data transformations, data formats, and/or augmented data that the collector instance 123 is to perform on the managed data before sending the managed data to agent 113 through broker 143.

Once configured, each specific running instance of collector 133 sends a topic and a message to agent 113 through broker 143 utilizing a programming and OS agnostic protocol. The topic is a registration request and the message comprises machine identifying information (obtained from the configuration files by the collector instance 133) for the specific managed device 120 that the collector instance 133 is collecting managed data for. Optionally, the message may further comprise data provider identifying information for the data provider 123 or data providers 123 that the collector instance 133 is configured to collect managed data from. Collector instance 133 receives a topic back from agent through broker 143 with a topic comprising an acknowledgment. This informs collector instance 133 that agent 113 is online and ready to receive managed data from collector instance 133 through broker 143.

When collector instance 133 fails to receive an acknowledgment back from agent 113, collector instance 133 maintains any obtained managed data in storage for sending to agent 113 when agent 113 is back online. Additionally, whenever collector instance 133 is unable to send topics and messages to broker 143 (indicating that collector instance 133 has lost a network connection), collector instance 133 maintains obtained managed data in storage for sending to agent 113 when collector instance 133 is able to establish a network connection. This ensures that no managed data is lost when connections are lost between for whatever reason.

Assuming agent 113 is online and assuming collector instance 133 (1 or N in FIG. 1B), collector instance 133 detects managed data produced by its data provider(s) 133 and formats the managed data (may transform and/or augment the manage data also) in accordance with its configuration and sends a topic and message to agent 113 through broker 143 comprising a topic of data and a message that includes the formatted managed data. The formatted managed data is retained in storage until collector instance 133 receives an acknowledgement topic in a topic from agent 113 through broker 143 (this ensures that the formatted managed data is not discarded by collector instance 133 until it is assured that agent 113 received the formatted managed data).

Agent 113 manages each collector instance 133 by maintaining unique identifiers for each collector instance 133 and maintaining the message contents associated with registration topics. The message contents may comprise managed device identifying information and/or data provider identifying information as discussed above.

Agent 113 receives data topics provided by the collector instances 133 through broker 143 and adds the corresponding managed device identifying information and/or data provider identifying information to each corresponding message contents the formatted managed data and sends the corresponding formatted managed data with the device identifying information to data collection servers/collection device 150 over one way secure connection 115, where it is written in the data collection and acquisition storage 153. The agent 113 may also add a transport header to the managed data when sent over one-way (outbound only no inbound connection) secure connection 115 (details of the transport header discussed below).

One the managed data with the managed device identifying information is written to the data collection and acquisition storage 153. Any remote device management system may acquire the management data for purposes of mining, analyzing, or processing within device management or resource management workflows. The manners in which the managed data is provided or obtained and subsequently processed may vary and be specific to the managed devices 120, specific to resources associated with the managed devices 120, and/or specific to an enterprise.

FIG. 1C is a diagram illustrating state process flows 100C of the system 100A from FIG. 1A, according to an example embodiment.

System 100A may operate in 3 primary states (170A, 170B, and 170C) and 5 total states (170A-1, 170B-1, 170B-2, 170C-1, and 170C-2). State 170A-1 shows the process flow for a collector instance 133 that is initialized or started; collector instance 133 posts a register topic and a message payload having its managed device identifying information with broker 143 utilizing the device, programming, and OS agnostic protocol; and broker 143 identifies agent 113 as being subscribed to receive posted registered topics causing broker 143 to forward the topic and message to agent 113; agent 113 posts an acknowledge topic with broker 143; and broker 143 identifies collector instance 133 as being subscribed to receive posted acknowledgments causing broker 143 to forward the acknowledgement topic to collector instance 133.

State 170B-1 shows the process flow for a collector instance that posts a data topic and a message payload comprising formatted managed data captured from its data provider(s) 123 for its managed device 120 with broker 143. Broker 143 identifies agent 113 as being subscribed to receive data topics and forwards the topic and message to agent 113. Agent 113 posts an acknowledgement topic with broker 143; broker 143 identifies subscribing collector instance 133 and forwards the topic to the collector instance 133.

State 170B-1 illustrates a collector instance 133 configured to send managed data without being prompted by agent 113 (dynamic push). The frequency with which the managed data is sent can be provided within the configuration files of collector instance 133. In some cases, the frequency is as soon as the managed data is obtained and formatted (real-time and on demand), in other cases the frequency is a predefined interval of time (every minute, every 5 minutes, every hour, etc.), etc.

State 170B-2 illustrates a collector instance 133 that is prompted via a collect topic posted by agent 113 with a management data request (dynamic pull requested by agent 113). Agent 113 posts the management data requested topic (collect topic) with broker 143; broker 143 identifies subscribing collector instance 133 and forwards the topic to collector instance 133. Collector instance 133 identifies the management data requested topic (collect topic) as an action to send its management data and performs the process flow associated with state 170B-1 (as discussed above).

States 170C-1 and 170C-2 illustrate conditions during which either agent 113 (state 170C-1) or collector instance 133 (state 170C-2) is offline. Both conditions resolve once connections are re-established when collector instance 133 is able to successful sending a registration topic and receive an acknowledgement topic back from agent 113 resulting in state 170A-1 being established. Collector instance 133 maintains all managed data collected in storage and sends from storage once state 170A-1 is established by entering state 170B-1.

FIG. 1D is a diagram illustrating process flows (180A and 180B) associated with collecting management data from a managed device 120 associated with the system 100A of FIG. 1A, according to an example embodiment. FIG. 1D illustrates two mechanism by which a collector instance 133 (1 or N in FIG. 1D) can obtain management data from its monitored data provider (1 or N in FIG. 1D).

Process flow 180A is event driven (dynamic push); at 1, collector instance 1 133 subscribes to receive event notifications for management data produced by data provider 1 123 (such as by registering for event notification with an OS of the corresponding managed device 120). When the event data is detected, at 2, collector instance 1 133 obtains the corresponding management data. At 3, collector instance 1 133 formats and/or transforms/augments the management data per its configuration. At 4, collector instance 1 133 posts a data topic and a messaging having contents or a message payload comprising the formatted managed data with broker 143.

Process flow 180B is request driven (dynamic pull); at 1, collector instance N 133 requests management data from data provider N 123; at 2, data provider N 123 provides the management data (file or log data) based on the request; at 3, collector instance N 133 formats and/or transforms/augments the management data per its configuration; and at 4, collector instance N 133 posts a data topic and a messaging having contents or a message payload comprising the formatted managed data with broker 143.

In an embodiment, agent 113 compresses the managed data and attaches the corresponding unique managed device identifying information for the corresponding managed device 120 associated with the managed data as a message header before sending over one-way secure connection 115 to data collection servers/collection device 150.

In an embodiment, agent 113 provides a transport header with the managed data before sending the managed data over the on-way secure connection 115 to data collection servers/collection device 150. The transport header is uncompressed and may include a message type, a unique message identifier, a message identifier sequence number, and a total number of sequence numbers for the unique message identifier. This is useful when the managed data is voluminous or large in size and requires splitting into packets and allows the consuming management applications that process the managed data to properly identify if all parts of the managed data were provided and properly assemble the parts in a correct order.

In an embodiment, collectors 133 can be specialized for certain types of managed data. For instance, an inventory collector 133 collects and publishes managed data that inventories hardware, software, settings, and data files on a managed device 120.

In an embodiment, the hardware and OS agnostic protocol processed by collectors 133, broker 143, and agent 113 is a Message Queuing Telemetry Transport (MQTT) compliant Internet-of-Things (IoT) protocol. The protocol includes an MQTT compliant header and an MQTT compliant data format.

In an embodiment, broker 143 is an MQTT server-based application that bridges connections between collectors 133 and agent 113 utilizing an MQTT compliant protocol.

In an embodiment, one-way secure connection 115 is an encrypted connection.

In an embodiment, the managed device 120 is an Automated Teller Machine (ATM), a Point-Of-Sale (POS) terminal, a Self-Service Terminal (SST), a kiosk, a phone, a tablet, a laptop, a desktop computer, a wearable processing device, or an IoT device.

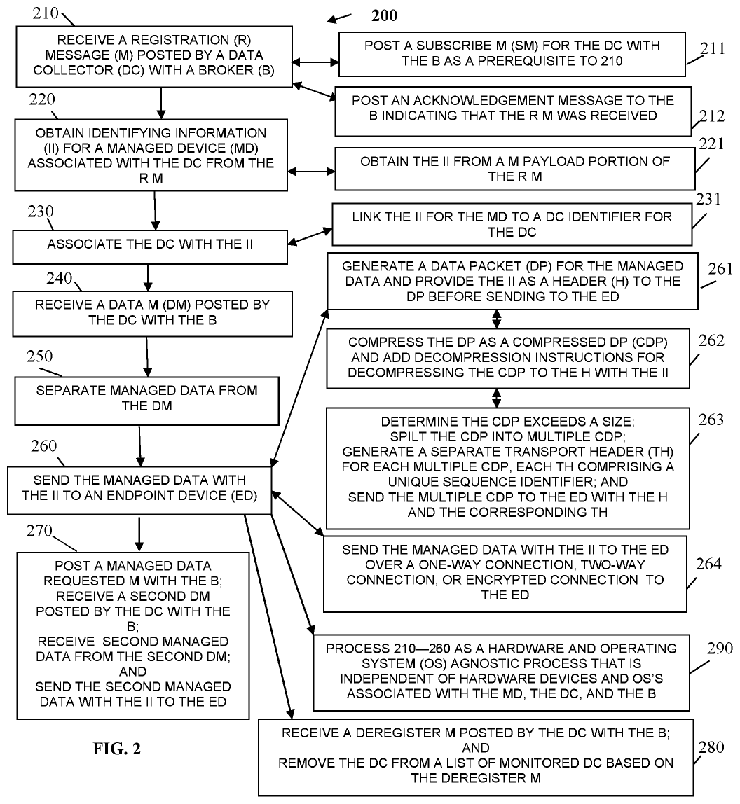

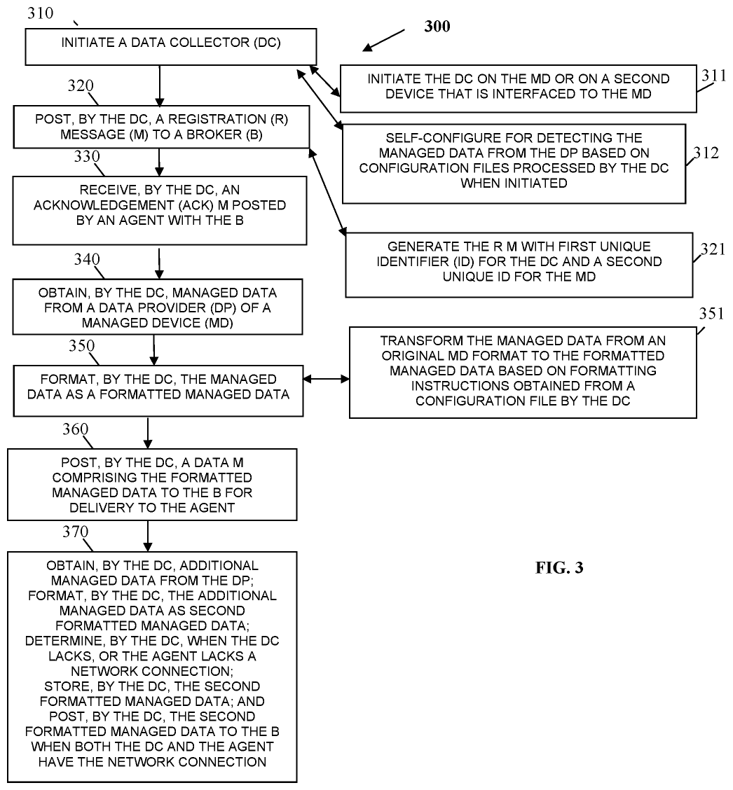

These and other embodiments will now be discussed with reference to FIGS. 2-3.

FIG. 2 is a diagram of a method 200 for operating an agnostic data collection platform, according to an example embodiment. The software module(s) that implements the method 200 is referred to as an “agnostic managed data agent.” The agnostic managed data agent is implemented as executable instructions programmed and residing within memory and/or a non-transitory computer-readable (processor-readable) storage medium and executed by one or more processors of a device. The processor(s) of the device that executes the agnostic managed data agent are specifically configured and programmed to process the agnostic managed data agent. The agnostic managed data agent may have access to one or more network connections during its processing. The network connections can be wired, wireless, or a combination of wired and wireless.

In an embodiment, the device that executes the agnostic managed data agent is server 110. In an embodiment, the server 110 is a cloud-based processing environment comprising a collection of physical servers cooperating as a single logical server (a cloud 110).

In an embodiment, the agnostic managed data agent agent 113.

At 210, agnostic managed data agent receives a registration message posted by a data collector with a broker. In an embodiment, the data collector is data collector 133 and the broker is broker 143 as discussed above with FIGS. 1A-1D.

In an embodiment, at 211, the agnostic managed data agent posts a subscribe message for the data collector with the broker as a prerequisite to 210.

In an embodiment, at 212, the agnostic managed data agent posts an acknowledgement message to the broker indicating that the registration message was received by the agnostic managed data agent.

At 220, the agnostic managed data agent obtains identifying information for a managed device associated with the data collector from the registration message. In an embodiment, the registration message is in an MQTT protocol format comprising a topic of registration and a message.

In an embodiment, at 221, the agnostic managed data agent obtains the identifying information from the message payload.

At 230, the agnostic managed data agent associates the data collector with the identifying information of the managed device.

In an embodiment, at 231, the agnostic managed data agent links the identifying information for the managed device to a data collector identifier for the data collector.

At 240, the agnostic managed data agent receives a data message posted by the data collector with the broker.

At 250, the agnostic managed data agent separates the managed data from the data message.

At 260, the agnostic managed data agent sends the managed data with the identifying information to an endpoint device.

In an embodiment, at 261, the agnostic managed data agent generates a data packet for the managed data and provides the identifying information for the managed device within a header to the data packet before sending the header and data packet to the endpoint device at 260.

In an embodiment of 261 and at 262, the agnostic managed data agent compresses the data packet as a compressed data packet and adds decompression instructions for decompressing the compressed data packet to the header with the identifying information for the managed device.

In an embodiment of 262 and at 262, the agnostic managed data agent determines that the compressed data packet exceeds a predefined data size. The agnostic managed data agent splits the compressed data packet into two or more (multiple) compressed data packets. The agnostic managed data agent generates a separate transport header for each of the multiple compressed data packets, each transport header comprises a unique message identifier for the managed data and a unique sequence identifier (which is unique to the corresponding transport header and the corresponding compressed data packet). The agnostic managed data agent sends the multiple compressed data packets to the endpoint device with the header and the corresponding transport headers that corresponding to multiple compressed data packets.

In an embodiment, at 264, the agnostic managed data agent sends the managed data with the identifying information for the managed device to the endpoint device over a one-way connection, two-way connection, or an encrypted connection to the endpoint device. In an embodiment, once the managed data is provided to the endpoint device, the agnostic managed data agent removes the managed data from the device and processing environment that processes the agnostic managed data agent. This ensures that no copies of the managed data reside within the processing environment of the agnostic managed data agent and provides added security to an owning enterprise associated with the managed data.

In an embodiment, at 270, the agnostic managed data agent posts a managed data requested message with the broker and receives a second data message posted by the data collector with the broker based on sending the managed data requested message. The agnostic managed data agent receives second managed data from the second data message and sends the second managed data with the identifying information to the endpoint device. The agnostic managed data agent also posts a second acknowledgement message with the broker so that the data collector can receive acknowledgment that the second managed data was received by the agnostic managed data agent.

In an embodiment, at 280, the agnostic managed data agent receives a deregister message posted by the data collector with the broker and responsive to the deregister message, the agnostic managed data agent removes an identifier for the data collector from a list of monitored data collector identifiers.

In an embodiment, at 290, the agnostic managed data agent processes as a hardware and OS agnostic process over a network. The agnostic managed data agent is independent of hardware devices and OS's associated with the managed device, the data collector, and the broker.

FIG. 3 is a diagram of another method 300 for operating an agnostic data collection platform, according to an example embodiment. The software module(s) that implements the method 300 is referred to as a “data collector.” The data collector is implemented as executable instructions programmed and residing within memory and/or a non-transitory computer-readable (processor-readable) storage medium and executed by one or more processors of a device. The processors that execute the data collector are specifically configured and programmed to process the data collector. The data collector may have access to one or more network connections during its processing. The network connections can be wired, wireless, or a combination of wired and wireless.

In an embodiment, the device that execute the data collector is managed device 120.

In an embodiment, the device that executes the data collector is LAN server/managed device 130.

In an embodiment, the data collector is an instance of collector 133 and/or loader 134.

The data collector interacts with method 200 of FIG. 2 to provided managed data in a hardware and OS agnostic manner for a managed device.

At 310, the data collector is initiated for monitoring managed data produced by data provider. In an embodiment, the data provider is data provider 123 and the managed device is managed device 120.

In an embodiment, at 311, the data data collector is initiated on the managed device 120 or on a second device 130 that is interfaced to the managed device 120.

In an embodiment, at 312, the data collector self-configures for detecting the managed data from the data provider based on configuration files processed by the data collector when initiated.

At 320, the data collector posts a registration message to a broker.

In an embodiment, at 321, the data collector generates the registration message with a first unique identifier for the data collector and a second unique identifier for the managed device.

At 330, the data collector receives an acknowledgement message posted by an agent with the broker.

At 340, the data collector obtains the managed data from the data provider of the managed device.

At 350, the data collector formats the managed data as formatted managed data.

In an embodiment, at 351, the data collector transforms the managed data from an original message data format to the formatted managed data based on formatting instructions obtained from a configuration file by the data collector.

At 360, the data collector posts a data message comprising the formatted managed data to the broker for delivery to the agent.

In an embodiment, at 370, the data collector obtains additional managed data from the data provider for the managed device, formats the additional managed data as second formatted managed data, determines that either the data collector or the agent lacks a network connection, stores the second formatted managed data, and posts the second formatted managed data to the broker when both the data collector and the agent have a network connection.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving a registration message posted by a data collector with a broker;
obtaining identifying information for a managed device associated with the data collector from the registration message;
associating the data collector with the identifying information;
receiving a data message posted by the data collector with the broker;
separating managed data from the data message; and
sending the managed data with the identifying information to an endpoint device.

2. The method of claim 1 further comprising:
posting a managed data requested message with the broker;
receiving a second data message posted by the data collector with the broker based on the posting;
receiving second managed data from the second data message; and
sending the second managed data with the identifying information to the endpoint device.

3. The method of claim 1 further comprising:
receiving a deregister message posted by the data collector with the broker; and
removing the data collector from a list of monitored data collectors based on the deregister message.

4. The method of claim 1 further comprising, processing the method as a hardware and Operating System (OS) agnostic process independent of hardware devices and OS's associated with the managed device, the data collector, and the broker.

5. The method of claim 1, wherein receiving further includes posting a subscribe message for the data collector with the broker as a prerequisite to receiving the registration message.

6. The method of claim 1, wherein receiving the registration message further includes posting an acknowledgement message to the broker indicating that the registration message was received.

7. The method of claim 1, wherein obtaining further includes obtaining the identifying information from a message payload portion of the registration message.

8. The method of claim 1, wherein associating further includes linking the identifying information for the managed device to a data collector identifier for the data collector.

9. The method of claim 1, wherein sending further includes generating a data packet for the managed data and providing the identifying information as a header to the data packet before sending to the endpoint device.

10. The method of claim 9, wherein generating further includes compressing the data packet as a compressed data packet and adding decompression instructions for decompressing the compressed data packet to the header with the identifying information.

11. The method of claim 10 further comprising:
determining the compressed data packet exceeds a predefined data size;
splitting the compressed data packet into two or more compressed data packets;
generating a separate transport header for each of the two or more compressed data packets, each separate transport header comprises a managed data message identifier for the managed data, a unique sequence number for the corresponding compressed data packet, and a total number of the two or more compressed data packets; and
sending each of the two or more compressed data packets to the endpoint device with the header and the corresponding separate transport header.

12. The method of claim 1, wherein sending further includes one of:
sending the managed data with the identifying information to the endpoint device over a one-way connection to the endpoint device;
sending the managed data with the identifying information to the endpoint device over a two-way connection to the endpoint device; or
sending the managed data with the identifying information to the endpoint device over an encrypted connection to the endpoint device.

13. A method, comprising:
initiating a data collector;
posting, by the data collector, a registration message to a broker;
receiving, by the data collector, an acknowledgement message posted by an agent with the broker;
obtaining, by the data collector, managed data from a data provider of a managed device;
formatting, by the data collector, the managed data as a formatted managed data; and
posting, by the data collector, a data message comprising the formatted managed data to the broker for delivery by the broker to the agent.

14. The method of claim 13 further comprising:
obtaining, by the data collector, additional managed data from the data provider;
formatting, by the data collector, the additional managed data as second formatted managed data;
determining, by the data collector, when the data collector lacks, or the agent lacks a network connection;
storing, by the data collector, the second formatted managed data; and
posting, by the data collector, the second formatted managed data to the broker when both the data collector and the agent have the network connection.

15. The method of claim 13, wherein initiating further includes initiating the data collector on the managed device or on a second device that is interfaced to the managed device.

16. The method of claim 13, wherein initiating further includes self-configuring for detecting the managed data from the data provider based on configuration files processed by the data collector when initiated.

17. The method of claim 13, wherein posting the registration message further includes generating the registration message with a first unique identifier for the data collector and a second unique identifier for the managed device.

18. The method of claim 13, wherein formatting further includes transforming the managed data from an original managed device format to the formatted managed data based on formatting instructions obtained from a configuration file by the data collector.

19. A system, comprising:
a server comprising a processor and a non-transitory computer-readable storage medium having executable instructions;
a managed device comprising a device processor and a device non-transitory computer-readable storage medium having device executable instructions;
the device executable instructions when executed by the device processor from the device non-transitory computer-readable storage medium cause the device processor to perform first operations comprising:
posting a registration message to a broker, wherein the registration message comprising a first identifier for the device executable instructions and a second identifier for the managed device;
receiving an acknowledgement message posted by the executable instructions with the broker;
obtaining managed data from a data provider of the managed device;
formatting the managed data as formatted managed data;
posting a data message to the broker, wherein the data message comprising the formatted managed data; and
receiving a second acknowledgement message posted by the executable instructions with the broker;
the executable instructions when executed by the processor from the non-transitory computer-readable storage medium cause the processor to perform operations comprising:
receiving the registration message posted with the broker by the second executable instructions;
posting the acknowledgment message to the broker;
obtaining the first identifier and the second identifier from the registration message;
linking the first identifier with the second identifier;
receiving the data message posted with the broker by the second executable instructions;
posting the second acknowledgement message to the broker;
obtaining the second identifier that is associated with the managed device and linked to the first identifier that is associated with the second executable instructions based on the data message;
obtaining the managed data from the data message; and
sending the managed data with a header comprising the second identifier over a one-way and encrypted connection to an endpoint device.

20. The system of claim 19, the managed device is an Automated Teller Machine (ATM), a Point-Of-Sale (POS) terminal, a Self-Service Terminal (SST), a kiosk, a tablet, a laptop, a desktop computer, a wearable processing device, or an Internet-of-Things (IoT) device.
